(19) United States
(12) Patent Application Publication
(10) Pub. No.: US 2025/0312867 A1
(43) Pub. Date: Oct. 9, 2025

(54) SHIELDING GAS SUPPLY DEVICE AND METHOD

(71) Applicant: MITSUBISHI HEAVY INDUSTRIES, LTD., Tokyo (JP)

(72) Inventors: Yoshinao KOMATSU, Tokyo (JP); Shuji TANIGAWA, Tokyo (JP)

(73) Assignee: MITSUBISHI HEAVY INDUSTRIES, LTD., Tokyo (JP)

(21) Appl. No.: 18/881,639

(22) PCT Filed: Feb. 21, 2023
(86) PCT No.: PCT/JP2023/006274

§ 371 Date: Jan. 6, 2025

(30) Foreign Application Priority Data
Jul. 8, 2022 (JP) 2022-110751

(51) Int. Cl. B23K 26/14

(52) U.S. Cl. CPC B23K 26/1476; B23K 26/1435

(57) ABSTRACT

A shielding gas supply device and a method include a first nozzle that jets first shielding gas along a shield surface at a first velocity set in advance, and a second nozzle that is disposed on an outer side of the first nozzle and jets second shielding gas along the first shielding gas at a second velocity lower than the first velocity.

### FIELD

The present invention relates to a shielding gas supply device and a method.

### BACKGROUND

At the time of irradiating a metal processing surface with a laser beam, an electron beam, and the like to perform various kinds of processing, the shielding gas supply device supplies shielding gas to the processing surface to prevent oxidation. A conventional shielding gas supply device is disclosed in the following Patent Literature 1.

### CITATION LIST

### Patent Literature

Patent Literature 1: Japanese Patent Application Laid-open No. 2014-161909

### SUMMARY

### Technical Problem

The shielding gas supply device needs to appropriately adjust a jetting amount of shielding gas jetted to the processing surface. If the jetting amount of the shielding gas is small in the shielding gas supply device, the processing surface is not sufficiently shielded by the shielding gas, so that it is difficult to prevent oxidation of the processing surface. On the other hand, if the jetting amount of the shielding gas is large in the shielding gas supply device, it is effective to prevent oxidation of the processing surface but running cost is increased. If a jetting velocity of the shielding gas is high in the shielding gas supply device, the shielding gas entrains surrounding air, so that oxygen is brought into contact with the processing surface, and it becomes difficult to prevent oxidation.

The present disclosure solves the problem described above, and an object thereof is to provide a shielding gas supply device that improves shield performance by suppressing entrainment of surrounding air into the shielding gas.

### Solution to Problem

In order to achieve the above object, a shielding gas supply device according to the present disclosure includes: a first nozzle configured to jet first shielding gas along a shield surface at a first velocity set in advance; and a second nozzle that is disposed on an outer side of the first nozzle and configured to jet second shielding gas along the first shielding gas at a second velocity lower than the first velocity.

Further, a shielding gas supply method according to the present disclosure includes the steps of: jetting first shielding gas along a shield surface at a first velocity set in advance; and jetting second shielding gas along and outside the first shielding gas at a second velocity lower than the first velocity.

### Advantageous Effects of Invention

With the shielding gas supply device and method according to the present disclosure, shield performance can be improved by suppressing entrainment of surrounding air into shielding gas.

### BRIEF DESCRIPTION OF DRAWINGS

FIG. 1 is a perspective view illustrating a shielding gas supply device according to a present embodiment.

FIG. 2 is a front view illustrating the shielding gas supply device.

FIG. 3 is a side view illustrating the shielding gas supply device.

FIG. 4 is a plan view illustrating the shielding gas supply device.

FIG. 5 is an exploded perspective view illustrating an inner part of the shielding gas supply device.

FIG. 6 is a graph representing a position in a nozzle curved surface height direction and a second derivative of a nozzle curved surface of the shielding gas supply device with respect to a position in a nozzle axis direction.

FIG. 7 is a schematic diagram for explaining a function of a conventional shielding gas supply device.

FIG. 8 is a schematic diagram for explaining a function of the shielding gas supply device according to the present embodiment.

FIG. 9 is a front view illustrating a first modification of a first nozzle and a second nozzle.

FIG. 10 is a front view illustrating a second modification of the first nozzle and the second nozzle.

FIG. 11 is a front view illustrating a third modification of the first nozzle and the second nozzle.

FIG. 12 is a front view illustrating a fourth modification of the first nozzle and the second nozzle.

FIG. 13 is a front view illustrating a fifth modification of the first nozzle and the second nozzle.

FIG. 14 is a front view illustrating a sixth modification of the first nozzle and the second nozzle.

FIG. 15 is a front view illustrating a seventh modification of the first nozzle and the second nozzle.

FIG. 16 is a front view illustrating an eighth modification of the first nozzle and the second nozzle.

FIG. 17 is a side view illustrating a ninth modification of the first nozzle and the second nozzle.

### DESCRIPTION OF EMBODIMENTS

The following describes a preferred embodiment of the present disclosure in detail with reference to the drawings. The present disclosure is not limited to this embodiment, and in a case in which there are a plurality of embodiments, the embodiments may be combined with each other. Constituent elements in the embodiment encompass a constituent element that is easily conceivable by those skilled in the art, substantially the same constituent element, and what is called an equivalent.

### Outline of Shielding Gas Supply Device

A shielding gas supply device according to the present embodiment is, for example, applied to a three-dimensional laminating device that forms a three-dimensional laminated body using powder such as metal powder as a raw material. As an example of a laminate shaping method by the three-dimensional laminating device, there is known a powder bed system in which a smooth surface of metal powder in a processing object is irradiated with a laser beam or an electron beam to be fused. At this point, the shielding gas supply device supplies inert gas along the smooth surface of the metal powder to prevent oxygen from being brought into contact with a processing surface, and prevents oxidation of the processing surface. However, the shielding gas supply device according to the present embodiment can be applied not only to the three-dimensional laminating device but also to another processing device (for example, an arc welding device and the like) that performs various kinds of processing using a laser beam and the like.

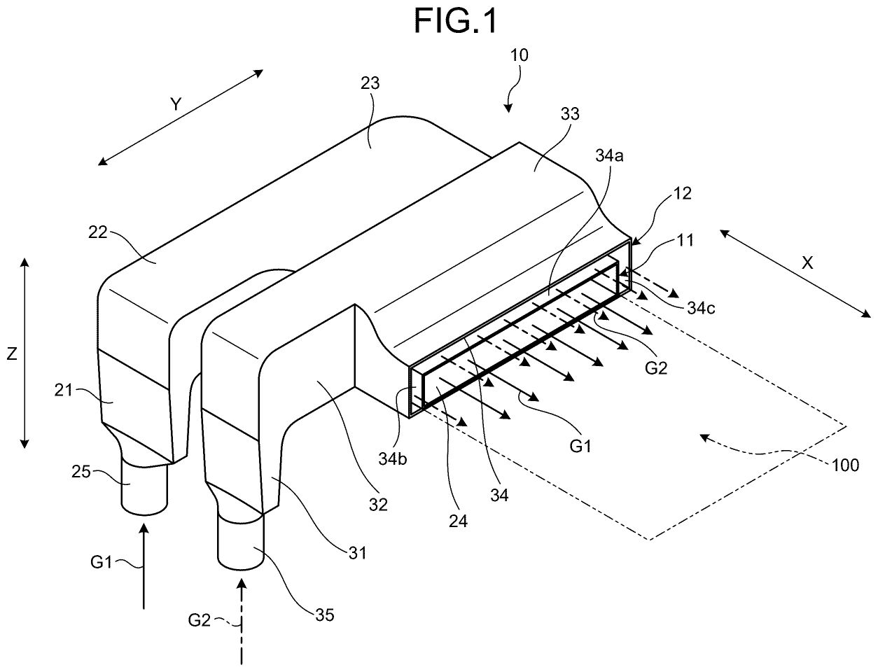

FIG. 1 is a perspective view illustrating the shielding gas supply device according to the present embodiment.

As illustrated in FIG. 1, a shielding gas supply device 10 includes a first nozzle 11 and a second nozzle 12.

The first nozzle 11 jets first shielding gas G1 along a shield surface 100 at a first velocity set in advance. The second nozzle 12 is disposed on an outer side of the first nozzle 11. The second nozzle 12 jets second shielding gas G2 along and around the first shielding gas G1 at a second velocity lower than the first velocity. In this case, a jetting direction of the first shielding gas G1 from the first nozzle 11 is the same as a jetting direction of the second shielding gas G2 from the second nozzle 12.

In the present embodiment, the shield surface 100 is a plane along a horizontal direction, and the shielding gas supply device 10 jets the shielding gas G1 and G2 on the shield surface 100 along the shield surface 100. That is, the jetting direction of the shielding gas G1 and G2 jetted by the shielding gas supply device 10 is a direction parallel with the shield surface 100. In the following direction, a horizontal direction parallel with the jetting direction of the shielding gas G1 and G2 is assumed to be an X-direction, a horizontal direction that is orthogonal to the X-direction parallel with the jetting direction of the shielding gas G1 and G2 and is parallel with the shield surface 100 is assumed to be a Y-direction, and a vertical direction orthogonal to the X-direction and the Y-direction, which are horizontal directions, is assumed to be a Z-direction.

### Configuration of Shielding Gas Supply Device

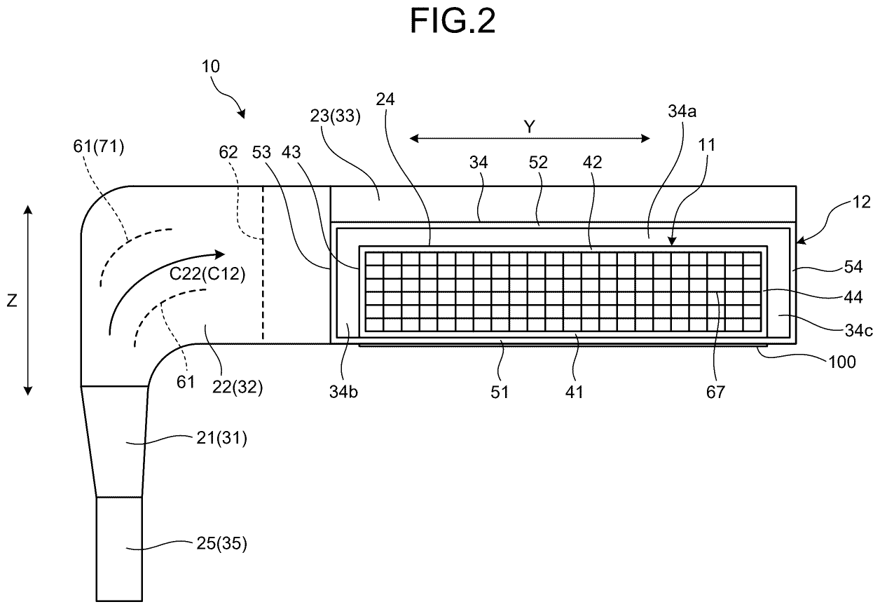

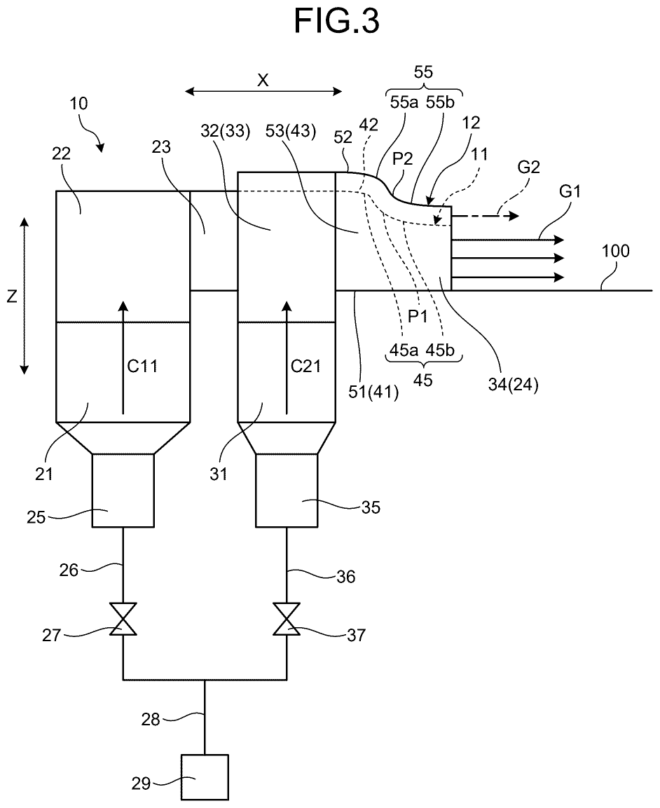

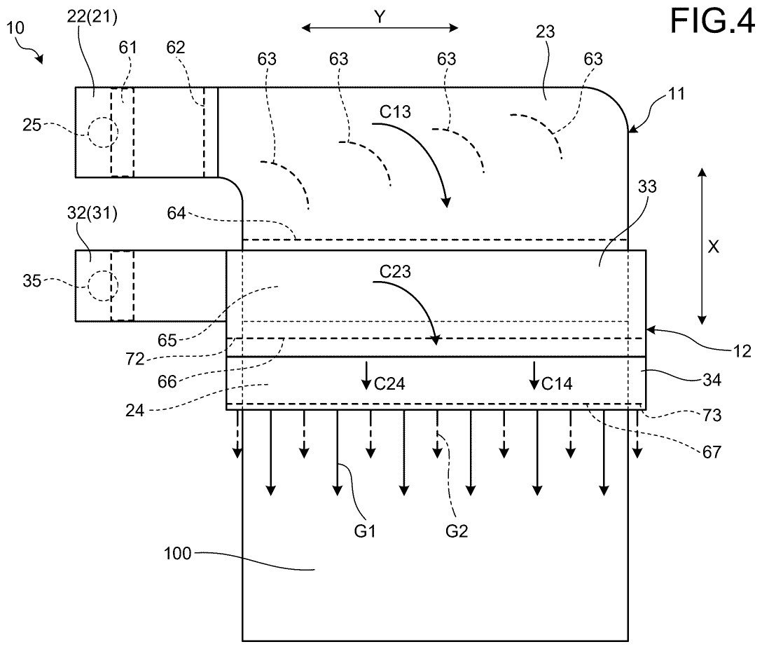

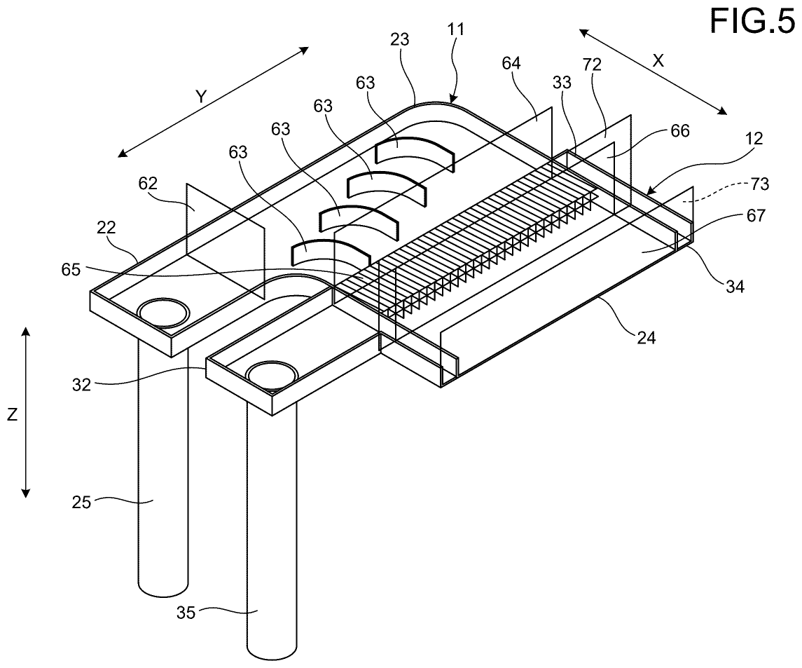

FIG. 2 is a front view illustrating the shielding gas supply device, FIG. 3 is a side view illustrating the shielding gas supply device, FIG. 4 is a plan view illustrating the shielding gas supply device, and FIG. 5 is an exploded perspective view illustrating an inner part of the shielding gas supply device.

As illustrated in FIG. 2 to FIG. 5, the first nozzle 11 includes a coupling part 21, a first bending part 22, a second bending part 23, and a nozzle part 24.

The coupling part 21 has a rectangular hollow shape, and a first flow channel C11 along the Z-direction is formed therein. A supply pipe 25 is coupled to a lower end part in the Z-direction of the coupling part 21. One end part of the first bending part 22 is coupled to an upper end part in the Z-direction of the coupling part 21. The first bending part 22 has a rectangular hollow shape, and a second flow channel C12 that is bent by substantially 90 degrees from the Z-direction to the Y-direction is formed therein. One end part of the second bending part 23 is coupled to the other end part of the first bending part 22. The second bending part 23 has a rectangular hollow shape, and a third flow channel C13 that is bent by substantially 90 degrees from the Y-direction to the X-direction is formed therein. One end part of the nozzle part 24 is coupled to the other end part of the second bending part 23. The nozzle part 24 has a rectangular hollow shape, and a fourth flow channel C14 along the X-direction is formed therein. The other end part of the nozzle part 24 opens toward the shield surface 100.

The second nozzle 12 includes a coupling part 31, a first bending part 32, a second bending part 33, and a nozzle part 34.

The coupling part 31 has a rectangular hollow shape, and a first flow channel C21 along the Z-direction is formed therein. A supply pipe 35 is coupled to a lower end part in the Z-direction of the coupling part 31. One end part of the first bending part 32 is coupled to an upper end part in the Z-direction of the coupling part 31. The first bending part 32 has a rectangular hollow shape, and a second flow channel C22 that is bent by substantially 90 degrees from the Z-direction to the Y-direction is formed therein. One end part of the second bending part 33 is coupled to the other end part of the first bending part 32. The second bending part 33 has a rectangular hollow shape, and a third flow channel C23 that is bent by substantially 90 degrees from the Y-direction to the X-direction is formed therein. One end part of the nozzle part 34 is coupled to the other end part of the second bending part 33. The nozzle part 34 has a rectangular hollow shape, and a fourth flow channel C24 along the X-direction is formed therein. The other end part of the nozzle part 34 opens toward the shield surface 100.

The coupling part 21, the first bending part 22, and the second bending part 23 of the first nozzle 11 and the coupling part 31, the first bending part 32, and the second bending part 33 of the second nozzle 12 are disposed to be shifted from each other in the X-direction by a predetermined distance. The second bending part 33 and the nozzle part 34 of the second nozzle 12 are disposed on an outer side of the second bending part 23 and the nozzle part 24 of the first nozzle 11. That is, the second bending part 33 and the nozzle part 34 of the second nozzle 12 cover upper sides and lateral sides in a right and left direction of the second bending part 23 and the nozzle part 24 of the first nozzle 11 with a predetermined gap. As a result, the nozzle part 34 of the second nozzle 12 includes a first jetting port 34a on the upper side of the first nozzle 11 and second jetting ports 34b and 34c in the right and left direction (width direction) of the first nozzle 11.

In the first nozzle 11, one end part of a first supply flow channel 26 is coupled to the supply pipe 25, and a first flow rate regulating valve 27 is disposed in the first supply flow channel 26. In the second nozzle 12, one end part of a second supply flow channel 36 is coupled to the supply pipe 35, and a second flow rate regulating valve 37 is disposed in the second supply flow channel 36. The other end parts of the first supply flow channel 26 and the second supply flow channel 36 are coupled to a supply flow channel 28 to merge with each other, and a supply source 29 is coupled to the supply flow channel 28. The supply source 29 can store inert gas as the shielding gas G1 and G2. Herein, for example, nitrogen gas (N₂), argon gas (Ar), helium gas (He), or the like is used as the inert gas.

The first nozzle 11 adjusts a supply amount of the first shielding gas G1 by adjusting an opening of the first flow rate regulating valve 27, and a flow velocity (a flow rate per unit time) of the first shielding gas G1 jetted from the nozzle part 24 is adjusted. The second nozzle 12 adjusts a supply amount of the second shielding gas G2 by adjusting an opening of the second flow rate regulating valve 37, and a flow velocity (a flow rate per unit time) of the second shielding gas G2 jetted from the nozzle part 34 is adjusted. In the shielding gas supply device 10, the second velocity of the shielding gas G2 jetted from the second nozzle 12 is lower than the first velocity of the first shielding gas G1 jetted from the first nozzle 11.

Thus, the first nozzle 11 jets the first shielding gas G1 along the shield surface 100 at a high velocity, and the second nozzle 12 jets the second shielding gas G2 along and outside the first shielding gas G1 excluding the shield surface 100 side at a low velocity. The first shielding gas G1 is then mixed with the surrounding second shielding gas G2 and takes in part of the second shielding gas G2 at an interface between the first shielding gas G1 and the second shielding gas G2. At an interface between the second shielding gas G2 and surrounding air, the second shielding gas G2 is mixed with the surrounding air and takes in part of the air.

The second velocity of the second shielding gas G2 is low, and lower than the first velocity of the first shielding gas G1. Accordingly, the second shielding gas G2 at the low velocity takes in a small amount of the surrounding air. The first shielding gas G1 at the high velocity takes in a large amount of the surrounding second shielding gas G2, but oxygen (air) is prevented from being mixed into the first shielding gas G1 because the second shielding gas G2 is inert gas.

As described above, based on a spreading angle and an entrainment velocity of an entraining flow in the first shielding gas G1 from the first nozzle 11, an induced flow velocity from the second shielding gas G2 as a surrounding space is substantially ⅕ to ⅙ of the first velocity of the first shielding gas G1 from the first nozzle 11. Accordingly, if the second velocity of the second shielding gas G2 from the second nozzle 12 is ⅕ or less of the first velocity, the second velocity of the second shielding gas G2 is accelerated to the entrainment velocity by the first shielding gas G1 from the first nozzle 11, and the entraining flow is hardly caused by the second shielding gas G2 at a low velocity. Thus, the second velocity of the second shielding gas G2 is preferably ⅕ or less (⅕ to ⅙) of the first velocity of the first shielding gas G1. On the other hand, if the second velocity of the second shielding gas G2 exceeds ⅕ of the first velocity of the first shielding gas G1, an additional entraining flow is caused by the second shielding gas G2 itself at a low velocity, and a circular vortex is generated in a space where there is surrounding air.

### Shape of Nozzle Part

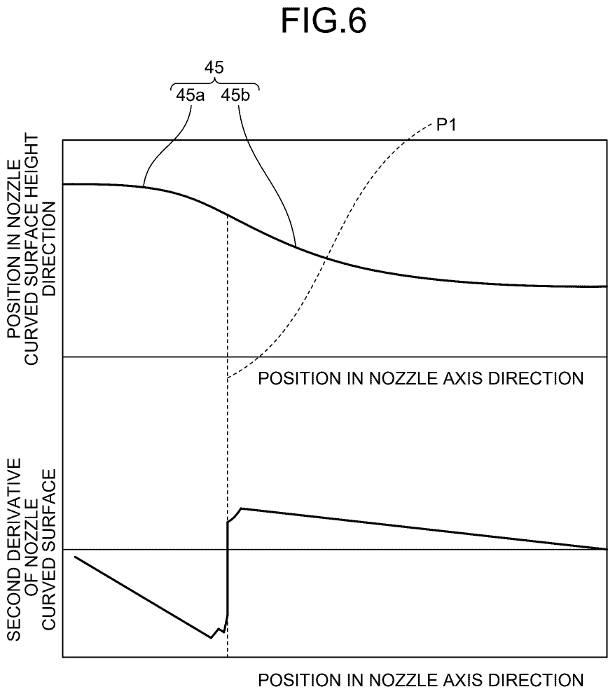

FIG. 6 is a graph representing a position in a nozzle curved surface height direction and a second derivative of a nozzle curved surface of the shielding gas supply device with respect to a position in a nozzle axis direction.

As illustrated in FIG. 2 and FIG. 3, in the first nozzle 11, the nozzle part 24 includes a lower wall 41, an upper wall 42, and left and right side walls 43 and 44. In the nozzle part 24, an inner surface of the lower wall 41 and an inner surface of the upper wall 42 are parallel with each other, and inner surfaces of the left and right side walls 43 and 44 are parallel with each other. In the nozzle part 24, a rectangular flow channel is formed by the lower wall 41, the upper wall 42, and the left and right side walls 43 and 44. It is preferable that the inner surface of the lower wall 41 is parallel with the shield surface 100, and continuous thereto without a step.

The nozzle part 24 is formed with a curved surface with which an area of the flow channel is gradually reduced toward a downstream side of a flowing direction of the first shielding gas G1. As illustrated in FIG. 3 and FIG. 6, in the nozzle part 24, a curved surface part 45 formed with a curved surface is formed on the upper wall 42. The curved surface part 45 includes an upstream side curved surface 45a projecting outward on an upstream side of the flowing direction of the first shielding gas G1, and a downstream side curved surface 45b projecting inward on the downstream side of the flowing direction of the first shielding gas G1. On the curved surface part 45, an inflection point P1 is provided between the upstream side curved surface 45a and the downstream side curved surface 45b. The inflection point P1 is present at a cross section passing through the center of gravity of the first nozzle 11. In the upper wall 42, it is preferable that an upstream side parallel part parallel with the lower wall 41 is disposed on the upstream side of the flowing direction of the first shielding gas G1 with respect to the curved surface part 45, and a downstream side parallel part parallel with the lower wall 41 is disposed on the downstream side of the flowing direction of the first shielding gas G1 with respect to the curved surface part 45.

Herein, the shape of the upper wall 42 (curved surface part 45) of the nozzle part 24 is represented by a second derivative. For example, when there is a function y=f(x) defined in one section on a number line and a finite limit value for x belonging to this section is present, the function f can be differentiated at x. This limit value (a rate of increase) is referred to as a differential coefficient (derivative) of the function f at x. That is, a second derivative of the upstream side curved surface 45a is negative (minus), a second derivative of the downstream side curved surface 45b is positive (plus), and the inflection point P1 is positioned between the upstream side curved surface 45a and the downstream side curved surface 45b. The inflection point P1 is a point at which the second derivative is changed from negative to positive.

In the present embodiment, the nozzle part 24 of the first nozzle 11 is parallel with the shield surface 100, and has a long rectangular shape along the width direction (Y-direction) orthogonal to the flowing direction of the first shielding gas G1. The curved surface part 45 having the inflection point P1 is disposed at least on the upper wall 42 opposed to the shield surface 100, that is, a surface adjacent to the first jetting port 34a of the second nozzle 12. The curved surface part having the inflection point may be disposed not only on the upper wall 42 but also on the left and right side walls 43 and 44, that is, surfaces adjacent to the second jetting ports 34b and 34c of the second nozzle 12.

On the other hand, as illustrated in FIG. 2 and FIG. 3, the second nozzle 12 is disposed on the outer side of the first nozzle 11 to be parallel with the first nozzle 11. That is, in the second nozzle 12, the nozzle part 34 includes a lower wall 51, an upper wall 52, and left and right side walls 53 and 54. In the nozzle part 34, an inner surface of the lower wall 51 and an inner surface of the upper wall 52 are parallel with each other, and inner surfaces of the left and right side walls 53 and 54 are parallel with each other. In the nozzle part 34, a rectangular flow channel is formed by the lower wall 51, the upper wall 52, and the left and right side walls 53 and 54. The inner surface of the lower wall 51 is in contact with an outer surface of the lower wall 51 of the first nozzle 11.

The nozzle part 34 is formed with a curved surface with which the area of the flow channel is gradually reduced toward the downstream side of the flowing direction of the second shielding gas G2 in a state in which the first nozzle 11 is not disposed therein. In the nozzle part 34, a curved surface part 55 formed with a curved surface is formed on the upper wall 52. The curved surface part 55 includes an upstream side curved surface 55a projecting outward on the upstream side of the flowing direction of the first shielding gas G1, and a downstream side curved surface 55b projecting inward on the downstream side of the flowing direction of the first shielding gas G1. On the curved surface part 55, an inflection point P2 is provided between the upstream side curved surface 55a and the downstream side curved surface 55b. In the upper wall 52, it is preferable that an upstream side parallel part parallel with the lower wall 51 is disposed on the upstream side of the flowing direction of the second shielding gas G2 with respect to the curved surface part 55, and a downstream side parallel part parallel with the lower wall 51 is disposed on the downstream side of the flowing direction of the second shielding gas G2 with respect to the curved surface part 55.

When the shape of the upper wall 52 (curved surface part 55) of the nozzle part 34 is represented by a second derivative, similarly to the nozzle part 24, a second derivative of the upstream side curved surface 55a is negative (minus), a second derivative of the downstream side curved surface 55b is positive (plus), and the inflection point P2 is positioned between the upstream side curved surface 55a and the downstream side curved surface 55b. The inflection point P2 is a point at which the second derivative is changed from negative to positive.

In the present embodiment, the nozzle part 34 of the second nozzle 12 is parallel with the shield surface 100, and has a long rectangular shape along the width direction (Y-direction) orthogonal to the flowing direction of the second shielding gas G2. The curved surface part 55 having the inflection point P2 is disposed at least on the upper wall 52 opposed to the shield surface 100. In the nozzle part 34, actually, the flow channel through which the second shielding gas G2 flows is the flow channel between the nozzle part 24 and the nozzle part 34, and the area of the flow channel between the nozzle part 24 and the nozzle part 34 is substantially constant toward the downstream side of the flowing direction of the second shielding gas G2. The curved surface part having the inflection point may be disposed not only on the upper wall 52 but also on the left and right side walls 53 and 54.

Thus, the first nozzle 11 jets the first shielding gas G1 from the nozzle part 24 along the shield surface 100. At this point, the area of the flow channel is gradually reduced in the nozzle part 24, the nozzle part 24 includes the upstream side curved surface 45a and the downstream side curved surface 45b, and the inflection point P1 is positioned therebetween, so that the first shielding gas G1 does not come off from the inner surface of the upper wall 42 of the nozzle part 24 and the first velocity is increased. Velocity distribution of the first shielding gas G1 at the time of being jetted from a downstream end part of the nozzle part 24 is then equalized, and turbulence of the flow of the first shielding gas G1 is reduced. The second nozzle 12 jets the second shielding gas G2 from the nozzle part 34 around the first shielding gas G1. At this point, the nozzle part 34 includes the upstream side curved surface 55a and the downstream side curved surface 55b, and the inflection point P2 is positioned therebetween, so that the second shielding gas G2 does not come off from the inner surface of the upper wall 52 of the nozzle part 34.

### Baffle Plate

As illustrated in FIG. 2 to FIG. 5, the first nozzle 11 includes, as a baffle plate, a first guide vane 61, a porous plate 62, a second guide vane 63, a first mesh (wire net) 64, a honeycomb core 65, a second mesh (wire net) 66, and a third mesh (wire net) 67.

The first guide vane 61, the porous plate 62, the second guide vane 63, the first mesh 64, the honeycomb core 65, the second mesh 66, and the third mesh 67 are disposed in this order from the upstream side toward the downstream side of the flowing direction of the first shielding gas G1.

A plurality of the first guide vanes 61 are disposed at intervals in the second flow channel C12 of the first bending part 22. The porous plate 62 is disposed between the first bending part 22 and the second bending part 23. A plurality of the second guide vanes 63 are disposed at intervals in the third flow channel C13 of the second bending part 23. The first mesh 64, the honeycomb core 65, and the second mesh 66 are disposed between the second bending part 23 and the nozzle part 24. The third mesh 67 is disposed at a downstream side end part of the nozzle part 24 in the flowing direction of the first shielding gas G1.

Herein, the first mesh 64, the honeycomb core 65, and the second mesh 66 function as an upstream side baffle plate disposed on the upstream side of the flowing direction of the first shielding gas G1 with respect to the curved surface part 45, and the third mesh 67 functions as a downstream side baffle plate disposed on the downstream side of the flowing direction of the first shielding gas G1 with respect to the curved surface part 45. The first mesh 64, the honeycomb core 65, and the second mesh 66 as the upstream side baffle plate and the third mesh 67 as the downstream side baffle plate include partition parts along the flowing direction of the first shielding gas G1. Herein, the partition part is a wire net of the meshes 64, 66, and 67 made of a metallic material or a resin material, for example, and is a wall forming a cavity of the honeycomb core 65. A thickness of the partition part of the third mesh 67 as the downstream side baffle plate is smaller than thicknesses of the partition parts of the first mesh 64, the honeycomb core 65, and the second mesh 66 as the upstream side baffle plate. Herein, the thickness of the partition part is a length of the partition part in a direction orthogonal to the flowing direction of the first shielding gas G1. As the thickness of the partition part is smaller, rectification performance is higher. That is, as the thickness of the partition part is smaller, turbulence of the flow of the first shielding gas G1 is reduced.

On the other hand, the second nozzle 12 includes, as a baffle plate, a guide vane 71, a first mesh (wire net) 72, and a second mesh (wire net) 73. The guide vane 71, the first mesh 72, and the second mesh 73 are disposed in this order from the upstream side toward the downstream side of the flowing direction of the second shielding gas G2.

A plurality of the guide vanes 71 are disposed at intervals in the second flow channel C22 of the first bending part 32. The first mesh 72 is disposed between the second bending part 33 and the nozzle part 34. The second mesh 73 is disposed at the downstream side end part of the nozzle part 34 in the flowing direction of the second shielding gas G2. The first mesh 72 and the second mesh 73 are disposed at the same positions as the second mesh 66 and the third mesh 67 of the first nozzle 11, respectively, and they may be integrally formed.

The first guide vane 61, the porous plate 62, the second guide vane 63, the first mesh 64, the honeycomb core 65, the second mesh 66, and the third mesh 67 are disposed as the baffle plate in the first nozzle 11, but the configuration is not limited thereto. The guide vane 71, the first mesh 72, and the second mesh 73 are disposed as the baffle plate in the second nozzle 12, but the configuration is not limited thereto.

Thus, the first shielding gas G1 is first supplied from the supply pipe 25 to the coupling part 21 to flow through the first flow channel C11, and passes through the second flow channel C12 of the first bending part 22 to reach the second bending part 23. At this point, the first shielding gas G1 is guided by the first guide vane 61 and rectified by the porous plate 62. Next, the first shielding gas G1 passes through the third flow channel C13 of the second bending part 23 to reach the nozzle part 24. At this point, the first shielding gas G1 is guided by the second guide vane 63, and rectified by the first mesh 64, the honeycomb core 65, and the second mesh (wire net) 66. The first shielding gas G1 is rectified by the third mesh 67 to be jetted to the outside thereafter.

On the other hand, the second shielding gas G2 is first supplied from the supply pipe 35 to the coupling part 31 to flow through the first flow channel C21, and passes through the second flow channel C22 of the first bending part 32 to reach the second bending part 33. At this point, the second shielding gas G2 is guided by the guide vane 71. Next, the second shielding gas G2 passes through the third flow channel C23 of the second bending part 33 to reach the nozzle part 34. At this point, the second shielding gas G2 is rectified by the first mesh 72. The second shielding gas G2 is rectified by the second mesh 73 to be jetted to the outside thereafter.

The first shielding gas G1 and the second shielding gas G2 are jetted to the outside along the shield surface 100 after being rectified, so that velocity distribution at the time of being jetted from downstream end parts of the nozzle parts 24 and 34 is equalized, and turbulence of the flow of the first shielding gas G1 and the second shielding gas G2 is reduced.

### Shielding Gas Supply Method

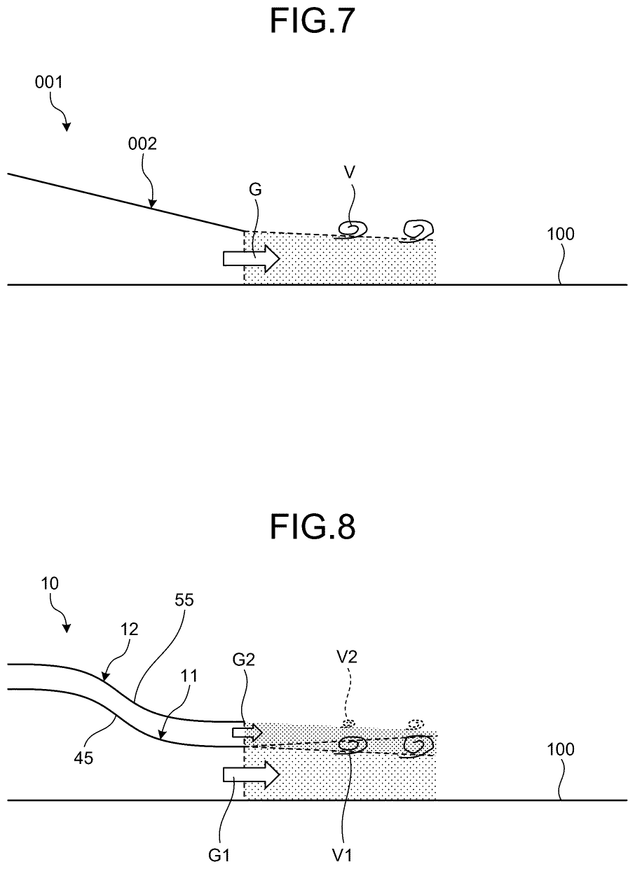

FIG. 7 is a schematic diagram for explaining a function of a conventional shielding gas supply device, and FIG. 8 is a schematic diagram for explaining a function of the shielding gas supply device according to the present embodiment.

A shielding gas supply method includes a step of jetting the first shielding gas G1 along the shield surface 100 at the first velocity set in advance, and a step of jetting the second shielding gas G2 along and outside the first shielding gas G1 excluding the shield surface 100 side at the second velocity lower than the first velocity.

That is, the first nozzle 11 jets the first shielding gas G1 from the nozzle part 24 along the shield surface 100 at the high velocity, and the second nozzle 12 jets the second shielding gas G2 from the nozzle part 34 around the first shielding gas G1 at the low velocity. At this point, the second velocity of the second shielding gas G2 is lower than the first velocity of the first shielding gas G1, so that the second shielding gas G2 takes in a small amount of the surrounding air, and the first shielding gas G1 takes in the surrounding second shielding gas G2. Accordingly, air (oxygen) is prevented from being mixed into the first shielding gas G1.

As illustrated in FIG. 7, in a conventional shielding gas supply device 001, an area of a flow channel in a nozzle part 002 is linearly (or curvedly) reduced toward a downstream side of a flowing direction of shielding gas G, and a velocity of the shielding gas G is the first velocity of the first shielding gas G1 in the present embodiment. Thus, a large vortex V is generated at an interface due to a velocity difference between the shielding gas G at a high velocity and surrounding air. Accordingly, the shielding gas G takes in a large amount of the surrounding air, and oxygen in the taken-in air may flow to the shield surface 100 and oxidize the processing surface.

On the other hand, the shielding gas supply device 10 according to the present embodiment includes the first nozzle 11 and the second nozzle 12 overlapping each other, and the second velocity of the second shielding gas G2 is lower than the first velocity of the first shielding gas G1. In the nozzle parts 24 and 34, the area of the flow channel is gradually reduced toward the downstream side of the flowing direction of the shielding gas G1 and G2, and the curved surface parts 45 and 55 having the inflection points P1 and P2 are disposed on the upper walls 42 and 52, respectively. Thus, the first shielding gas G1 does not come off from inner surfaces of the upper walls 42 and 52 of the nozzle parts 24 and 34, and velocity distribution at the time of being jetted to the shield surface 100 is equalized and turbulence of the flow is reduced.

A velocity difference between the second shielding gas G2 at the low velocity and the surrounding air is small, and a vortex V2 formed at the interface is small. Accordingly, the second shielding gas G2 takes in a small amount of the surrounding air. A velocity difference between the first shielding gas G1 at the high velocity and the surrounding second shielding gas G2 is also small, and the vortex V1 formed at the interface is also small. The second shielding gas G2 is inert gas that is the same as the first shielding gas G1, so that oxygen in the air taken in by the second shielding gas G2 hardly flows to the shield surface 100 via the first shielding gas G1, and oxidation of the processing surface is prevented.

### Modification of Nozzle

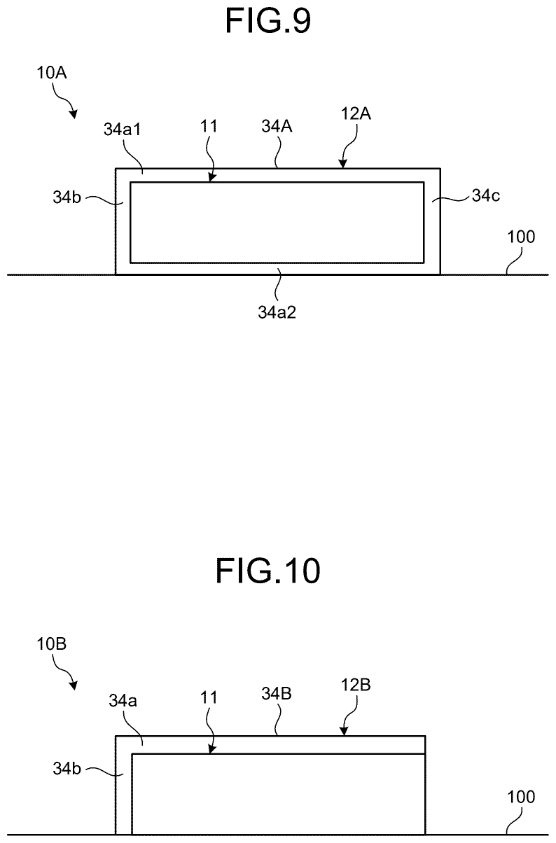

FIG. 9 is a front view illustrating a first modification of the first nozzle and the second nozzle.

In the first modification, as illustrated in FIG. 9, a shielding gas supply device 10A includes the first nozzle 11 and a second nozzle 12A. The first nozzle 11 is the same as that in the embodiment described above.

The second nozzle 12A includes a nozzle part 34A, and the nozzle part 34A includes first jetting ports 34a1 and 34a2 and the second jetting ports 34b and 34c. The first jetting port 34a1 is positioned on a side opposite to the shield surface 100 of the first nozzle 11, that is, on an upper side of the first nozzle 11. The first jetting port 34a2 is positioned on the shield surface 100 side of the first nozzle 11, that is, on a lower side of the first nozzle 11. The second jetting ports 34b and 34c are positioned on both sides in the right and left direction (width direction) of the first nozzle 11. Other configurations are the same as those in the embodiment described above.

The first nozzle 11 jets the first shielding gas G1 along the shield surface 100 at a high velocity, and the second nozzle 12 jets the second shielding gas G2 along and around the first shielding gas G1 at a low velocity.

FIG. 10 is a front view illustrating a second modification of the first nozzle and the second nozzle.

In the second modification, as illustrated in FIG. 10, a shielding gas supply device 10B includes the first nozzle 11 and a second nozzle 12B. The first nozzle 11 is the same as that in the embodiment described above.

The second nozzle 12B includes a nozzle part 34B, and the nozzle part 34B includes the first jetting port 34a and the second jetting port 34b. The first jetting port 34a is positioned on a side opposite to the shield surface 100 of the first nozzle 11, that is, on the upper side of the first nozzle 11, and the second jetting port 34b is positioned on one (left) side in the right and left direction (width direction) of the first nozzle 11. The second jetting port may be positioned on the other (right) side in the right and left direction (width direction) of the first nozzle 11. Other configurations are the same as those in the embodiment described above.

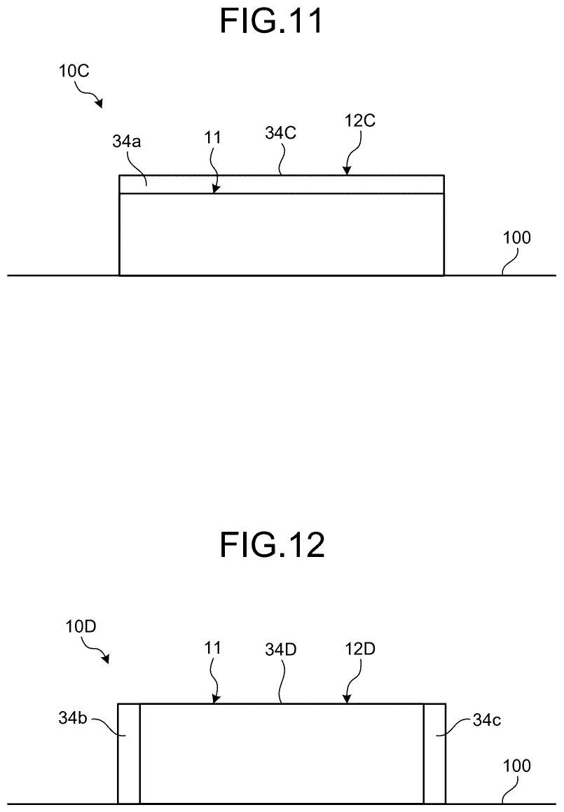

FIG. 11 is a front view illustrating a third modification of the first nozzle and the second nozzle.

In the third modification, as illustrated in FIG. 11, a shielding gas supply device 10C includes the first nozzle 11 and a second nozzle 12C. The first nozzle 11 is the same as that in the embodiment described above.

The second nozzle 12C includes a nozzle part 34C, and the nozzle part 34C includes the first jetting port 34a. The first jetting port 34a is positioned on a side opposite to the shield surface 100 of the first nozzle 11, that is, on the upper side of the first nozzle 11. Other configurations are the same as those in the embodiment described above.

FIG. 12 is a front view illustrating a fourth modification of the first nozzle and the second nozzle.

In the fourth modification, as illustrated in FIG. 12, a shielding gas supply device 10D includes the first nozzle 11 and a second nozzle 12D. The first nozzle 11 is the same as that in the embodiment described above.

The second nozzle 12D includes a nozzle part 34D, and the nozzle part 34D includes the second jetting ports 34b and 34c. The second jetting ports 34b and 34c are positioned on both sides in the right and left direction (width direction) of the first nozzle 11. Other configurations are the same as those in the embodiment described above.

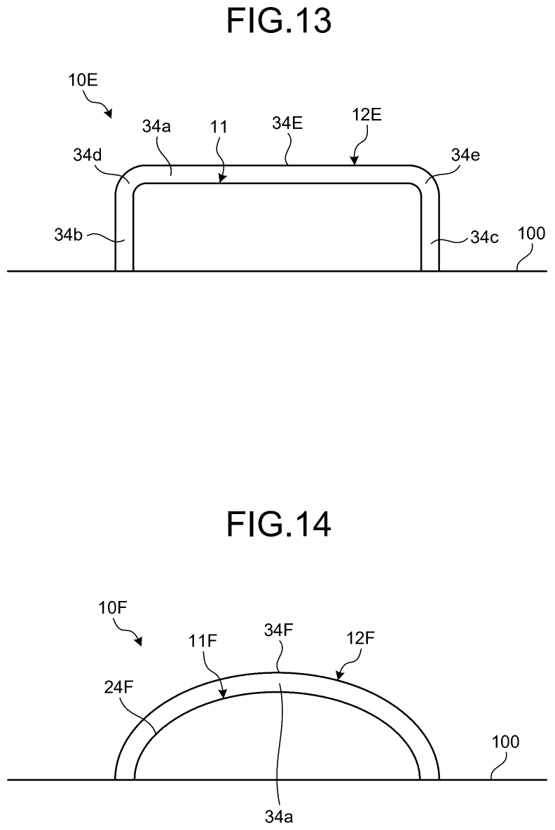

FIG. 13 is a front view illustrating a fifth modification of the first nozzle and the second nozzle.

In the fifth modification, as illustrated in FIG. 13, a shielding gas supply device 10E includes the first nozzle 11 and a second nozzle 12E. The first nozzle 11 is the same as that in the embodiment described above.

The second nozzle 12E includes a nozzle part 34E, and the nozzle part 34E includes the first jetting port 34a, the second jetting ports 34b and 34c, and third jetting ports 34d and 34e. The first jetting port 34a is positioned on a side opposite to the shield surface 100 of the first nozzle 11, that is, on the upper side of the first nozzle 11, and the second jetting ports 34b and 34c are positioned on both sides in the right and left direction (width direction) of the first nozzle 11. The third jetting ports 34d and 34e each have a curved shape (fillet shape). The third jetting port 34d causes the first jetting port 34a to communicate with the second jetting port 34b, and the third jetting port 34e causes the first jetting port 34a to communicate with the second jetting port 34c. Other configurations are the same as those in the embodiment described above.

FIG. 14 is a front view illustrating a sixth modification of the first nozzle and the second nozzle.

In the sixth modification, as illustrated in FIG. 14, a shielding gas supply device 10F includes a first nozzle 11F and a second nozzle 12F.

The first nozzle 11F has a semicircular shape, and includes a nozzle part 24F. The second nozzle 12F includes a nozzle part 34F, and the nozzle part 34F includes the first jetting port 34a. The first jetting port 34a is positioned on a side opposite to the shield surface 100 of the first nozzle 11F, that is, on the upper side of the first nozzle 11. The first jetting port 34a has a curved shape along a periphery of the first nozzle 11F having the semicircular shape. Other configurations are the same as those in the embodiment described above.

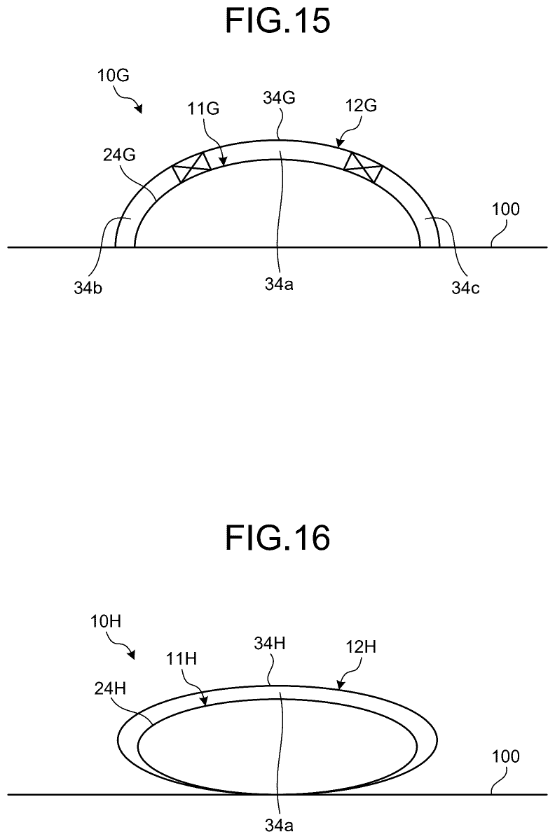

FIG. 15 is a front view illustrating a seventh modification of the first nozzle and the second nozzle.

In the seventh modification, as illustrated in FIG. 15, a shielding gas supply device 10G includes a first nozzle 11G and a second nozzle 12G.

The first nozzle 11G has a semicircular shape, and includes a nozzle part 24G. The second nozzle 12G includes a nozzle part 34G, and the nozzle part 34G includes the first jetting port 34a and the second jetting ports 34b and 34c. The first jetting port 34a is positioned on a side opposite to the shield surface 100 of the first nozzle 11G, that is, on the upper side of the first nozzle 11. The second jetting ports 34b and 34c are positioned on both sides in the right and left direction (width direction) of the first nozzle 11G. The first jetting port 34a and the second jetting ports 34b and 34c each have a curved shape along a periphery of the first nozzle 11G having the semicircular shape. An intermittent part is disposed between the first jetting port 34a and the second jetting port 34b, and an intermittent part is disposed between the first jetting port 34a and the second jetting port 34c. Other configurations are the same as those in the embodiment described above.

FIG. 16 is a front view illustrating an eighth modification of the first nozzle and the second nozzle.

In the eighth modification, as illustrated in FIG. 16, a shielding gas supply device 10H includes a first nozzle 11H and a second nozzle 12H.

The first nozzle 11H has an elliptical shape, and includes a nozzle part 24H. The second nozzle 12H includes a nozzle part 34H, and the nozzle part 34H includes the first jetting port 34a. The first jetting port 34a is positioned on an outer side of the first nozzle 11 excluding a portion adjacent to the shield surface 100 of the first nozzle 11H. The first jetting port 34a has a curved shape along a periphery of the first nozzle 11H having the elliptical shape. Other configurations are the same as those in the embodiment described above.

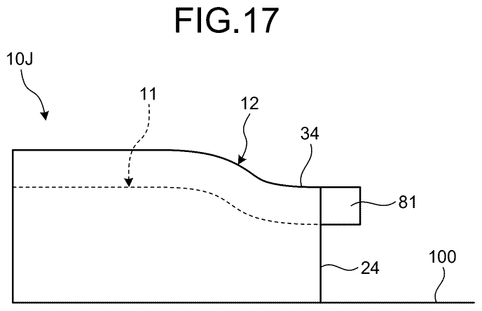

FIG. 17 is a side view illustrating a ninth modification of the first nozzle and the second nozzle.

In the ninth modification, as illustrated in FIG. 17, a shielding gas supply device 10J includes the first nozzle 11, the second nozzle 12, and a guide part 81.

The first nozzle 11 includes the nozzle part 24, and the nozzle part 24 is formed with a curved surface with which the area of the flow channel is gradually reduced toward the downstream side of the flowing direction of the first shielding gas G1. The second nozzle 12 is disposed on the outer side of the first nozzle 11, and includes the nozzle part 34. The nozzle part 34 is formed with a curved surface with which the area of the flow channel is gradually reduced toward the downstream side of the flowing direction of the second shielding gas G2.

The guide part 81 is disposed at a front end portion of the nozzle part 34 of the second nozzle 12. Thus, a jetting position of the second shielding gas G2 from the second nozzle 12 is the downstream side of the flowing direction of the shielding gas G1 and G2 with respect to a jetting position of the first shielding gas G1 from the first nozzle 11. The guide part 81 includes an inner flange and an outer flange of a jetting port of the second shielding gas G2 from the second nozzle 12. However, the guide part 81 may include only the inner flange of the jetting port of the second shielding gas G2 from the second nozzle 12, that is, only a flange between the jetting port of the first nozzle 11 and the jetting port of the second nozzle 12.

### Function and Effect of Present Embodiment

The shielding gas supply device according to a first aspect includes the first nozzle 11 that jets the first shielding gas G1 along the shield surface 100 at the first velocity set in advance, and the second nozzle 12 that is disposed on the outer side of the first nozzle 11 and jets the second shielding gas G2 along the first shielding gas G1 at the second velocity lower than the first velocity.

With the shielding gas supply device according to the first aspect, the first nozzle 11 jets the first shielding gas G1 along the shield surface 100, and the second nozzle 12 jets the second shielding gas G2 outside the first shielding gas G1 at a low velocity. Accordingly, the second shielding gas G2 at the low velocity takes in a small amount of the surrounding air. The first shielding gas G1 at the high velocity takes in a large amount of the surrounding second shielding gas G2, but oxygen (air) can be prevented from being mixed into the first shielding gas G1 because the second shielding gas G2 is inert gas.

Thus, the first shielding gas G1 flowing along the shield surface 100 contains little oxygen, so that shield performance for the processing surface can be secured. As a result, the shield performance can be improved by suppressing entrainment of the surrounding air into the first shielding gas G1.

Herein, it is sufficient that the second nozzle 12 can jet the gas at a flow rate corresponding to an entraining flow, so that a required supply amount of the first shielding gas G1 can be reduced and running costs can be reduced as compared with a case of upsizing the first nozzle 11 itself. A second flow velocity of the second shielding gas G2 jetted from the second nozzle 12 is low, so that the flow rate of the surrounding air taken in by a jetted flow of the second shielding gas G2 jetted from the second nozzle 12 is also reduced, and the second nozzle 12 can be downsized as compared with a case of upsizing the first nozzle 11.

The shielding gas supply device according to a second aspect is the shielding gas supply device according to the first aspect, in which the second velocity is ⅕ or less of the first velocity. Due to this, an entraining flow can be prevented from being generated by the second shielding gas G2 at the low velocity, a vortex can be prevented from being generated at an interface with the surrounding air, and the second nozzle 12 can be downsized.

The shielding gas supply device according to a third aspect is the shielding gas supply device according to the first aspect or the second aspect, in which the first nozzle 11 is formed with a curved surface with which the area of the flow channel is gradually reduced toward the downstream side of the flowing direction of the first shielding gas G1. Due to this, the first shielding gas G1 jetted from the nozzle part 24 does not come off from the curved surface part 45 of the upper wall 42, and the first velocity can be increased. As a result, the flow velocity of the first shielding gas G1 can be equalized, and turbulence (variation) of the flow of the first shielding gas G1 itself can be reduced.

The shielding gas supply device according to a fourth aspect is the shielding gas supply device according to the third aspect, in which the first nozzle 11 includes the upstream side curved surface 45a projecting outward on the upstream side of the flowing direction of the first shielding gas G1 and the downstream side curved surface 45b projecting inward on the downstream side of the flowing direction of the first shielding gas G1, and the inflection point P1 is provided at a cross section passing through the center of gravity of the first nozzle 11 between the upstream side curved surface 45a and the downstream side curved surface 45b. Due to this, flow velocity distribution at the jetting port of the nozzle part 24 can be equalized and turbulence (variation) of the flow of the first shielding gas G1 can be reduced by disposing the upstream side curved surface 45a and the downstream side curved surface 45b having the inflection point P1. By reducing flow velocity deviation and turbulence of the first shielding gas G1, mixing with the surrounding air can be suppressed, a smooth flow channel shape can be formed, and the first nozzle 11 can be downsized.

The shielding gas supply device according to a fifth aspect is the shielding gas supply device according to the third aspect or the fourth aspect, in which the second nozzle 12 has the jetting port having a rectangular shape, and the inflection point P1 is arranged on a side opposite to the shield surface with respect to the first nozzle 11. Due to this, velocity distribution of the first shielding gas G1 at the time of being jetted from the jetting port of the nozzle part 24 is equalized, turbulence of the flow of the first shielding gas G1 can be reduced, and the nozzle part 24 can be simplified.

The shielding gas supply device according to a sixth aspect is the shielding gas supply device according to the fifth aspect, in which the second nozzle 12 includes the first jetting port 34a disposed on a side opposite to the shield surface 100 with respect to the first nozzle 11 and the second jetting ports 34b and 34c disposed on at least one side of the width direction of the first nozzle 11. Due to this, the second shielding gas G2 is jetted so as to surround the first shielding gas G1 from the outer side of the first nozzle 11 excluding the shield surface 100 side, so that a supply amount of the first shielding gas G1 can be reduced, and the second nozzle 12 can be downsized. A distance from the shield surface 100 to the first jetting port 34a becomes constant, so that it is possible to obtain a uniform effect of preventing oxygen from entering the first shielding gas G1 from the surroundings.

In the shielding gas supply device according to a seventh aspect, the first jetting port 34a and the second jetting ports 34b and 34c communicate with each other via the third jetting ports 34d and 34e each having a curved shape. Due to this, a developing direction of a velocity shearing layer of a flow from the first jetting port 34a to the second jetting ports 34b and 34c is smoothly changed, and discontinuity of adjacent velocity shearing layers and bottom surface vortex flows is suppressed. Thus, it is possible to suppress interference of the velocity shearing layers and the vortex flows between the second shielding gas G2 from the first jetting port 34a and the second shielding gas G2 from the second jetting port 34b.

The shielding gas supply device according to an eighth aspect is the shielding gas supply device according to the sixth aspect, in which the inflection point is provided at a position opposed to the first jetting port 34a and the second jetting ports 34b and 34c. Due to this, velocity distribution of the first shielding gas G1 is equalized at a position adjacent to the first jetting port 34a and the second jetting ports 34b and 34c at the time of being jetted from the jetting port of the nozzle part 24, and turbulence of the flow of the first shielding gas G1 can be reduced.

The shielding gas supply device according to a ninth aspect is the shielding gas supply device according to any one of the first aspect to the fifth aspect, in which the second nozzle 12 is disposed in parallel with the first nozzle 11. Due to this, downsizing can be achieved by efficiently disposing the first nozzle 11 and the second nozzle 12, and a stable flow of the second shielding gas G2 can be formed outside the first shielding gas G1.

The shielding gas supply device according to a tenth aspect is the shielding gas supply device according to any one of the first aspect to the sixth aspect, in which, in the first nozzle 11, the upstream side baffle plate (the first mesh 64, the honeycomb core 65, and the second mesh 66) is disposed on the upstream side of the flowing direction of the first shielding gas G1 with respect to the curved surface, and the downstream side baffle plate (third mesh 67) is disposed on the downstream side of the flowing direction of the first shielding gas G1 with respect to the curved surface. Due to this, the first shielding gas G1 is jetted to the outside along the shield surface 100 after being rectified, velocity distribution at the time of being jetted from the nozzle part 24 is equalized, and turbulence of the flow of the first shielding gas G1 can be reduced.

The shielding gas supply device according to an eleventh aspect is the shielding gas supply device according to the eighth aspect, in which the upstream side baffle plate and the downstream side baffle plate include the partition parts along the flowing direction of the first shielding gas G1, and the thickness of the partition part of the downstream side baffle plate is smaller than that of the partition part of the upstream side baffle plate. Due to this, turbulence of the flow of the first shielding gas G1 jetted from the nozzle part 24 can be appropriately reduced. That is, rectification performance is higher as the thickness of the partition part is smaller, so that turbulence of the first shielding gas G1 jetted from the nozzle part 24 to the shield surface 100 can be reduced.

The shielding gas supply method according to a twelfth aspect includes a step of jetting the first shielding gas G1 along the shield surface 100 at the first velocity set in advance, and a step of jetting the second shielding gas G2 along and outside the first shielding gas G1 at the second velocity lower than the first velocity. Due to this, the shield performance can be improved by suppressing entrainment of the surrounding air into the first shielding gas G1.

In the embodiment described above, the first nozzle 11 and the second nozzle 12 respectively include the coupling parts 21 and 31, the first bending parts 22 and 32, the second bending parts 23 and 33, and the nozzle parts 24 and 34, but the configuration is not limited thereto. The first nozzle 11 and the second nozzle 12 are only required to include at least the nozzle parts 24 and 34, respectively.

In the embodiment described above, the first nozzle 11 and the second nozzle 12 each have a rectangular shape, but may have a circular shape and the like. The jetting direction of the shielding gas G1 and G2 jetted by the first nozzle 11 and the second nozzle 12 is the horizontal direction, but may be a vertical direction or a direction inclined with respect to the horizontal direction. The shield surface 100 is a plane, but may be a curved surface. In this case, the first nozzle 11 and the second nozzle 12 may have a shape matching the shape of the shield surface.

### REFERENCE SIGNS LIST

10, 10A, 10B, 10C, 10D, 10E, 10F, 10G, 10H, 10J SHIELDING GAS SUPPLY DEVICE
11, 11F, 11G, 11H FIRST NOZZLE
12, 12A, 12B, 12C, 12D, 12E, 12F, 12G, 12H SECOND NOZZLE
21, 31 COUPLING PART
22, 32 FIRST BENDING PART
23, 33 SECOND BENDING PART
24, 24F, 24G, 24H, 34, 34A, 34B, 34C, 34D, 34E, 34F, 34G NOZZLE PART
25, 35 SUPPLY PIPE
34a, 34a1, 34a2 FIRST JETTING PORT
34b, 34c SECOND JETTING PORT
34d, 34e THIRD JETTING PORT
41, 51 LOWER WALL
42, 52 UPPER WALL
43, 44, 53, 54 SIDE WALL
45, 55 CURVED SURFACE PART
45a, 55a UPSTREAM SIDE CURVED SURFACE
45b, 55b DOWNSTREAM SIDE CURVED SURFACE
61 FIRST GUIDE VANE
62 POROUS PLATE
63 SECOND GUIDE VANE
64 FIRST MESH (UPSTREAM SIDE BAFFLE PLATE)
65 HONEYCOMB CORE (UPSTREAM SIDE BAFFLE PLATE)
66 SECOND MESH (UPSTREAM SIDE BAFFLE PLATE)
67 THIRD MESH (DOWNSTREAM SIDE BAFFLE PLATE)
71 GUIDE VANE
72 FIRST MESH
73 SECOND MESH
81 GUIDE PART
100 SHIELD SURFACE
C11, C21 FIRST FLOW CHANNEL
C12, C22 SECOND FLOW CHANNEL
C13, C23 THIRD FLOW CHANNEL
C14, C24 FOURTH FLOW CHANNEL
G1 FIRST SHIELDING GAS
G2 SECOND SHIELDING GAS
P1, P2 INFLECTION POINT

1. A shielding gas supply device comprising:
a first nozzle configured to jet first shielding gas along a shield surface at a first velocity set in advance; and
a second nozzle that is disposed on an outer side of the first nozzle and configured to jet second shielding gas along the first shielding gas at a second velocity lower than the first velocity, wherein
the first nozzle is formed with a curved surface with which an area of a flow channel is gradually reduced toward a downstream side of a flowing direction of the first shielding gas,
the first nozzle includes an upstream side curved surface projecting outward on an upstream side of the flowing direction of the first shielding gas and a downstream side curved surface projecting inward on a downstream side of the flowing direction of the first shielding gas,
an inflection point is provided at a cross section passing through a center of gravity of the first nozzle between the upstream side curved surface and the downstream side curved surface,
the second nozzle includes a jetting port having a rectangular shape, and
the inflection point is arranged on a side opposite to the shield surface with respect to the first nozzle.

2. The shielding gas supply device according to claim 1, wherein the second velocity is ⅕ or less of the first velocity.

3. (canceled)

4. (canceled)

5. (canceled)

6. The shielding gas supply device according to claim 1, wherein the second nozzle includes a first jetting port disposed on a side opposite to the shield surface with respect to the first nozzle and a second jetting port disposed on at least one side of a width direction of the first nozzle.

7. The shielding gas supply device according to claim 6, wherein the first jetting port and the second jetting port communicate with each other via a third jetting port having a curved shape.

8. The shielding gas supply device according to claim 6, wherein the inflection point is provided at a position opposed to the first jetting port and the second jetting port.

9. The shielding gas supply device according to claim 1, wherein the second nozzle is disposed in parallel with the first nozzle.

10. The shielding gas supply device according to claim 1, wherein, in the first nozzle, an upstream side baffle plate is disposed on an upstream side of the flowing direction of the first shielding gas with respect to the curved surface, and a downstream side baffle plate is disposed on a downstream side of the flowing direction of the first shielding gas with respect to the curved surface.

11. The shielding gas supply device according to claim 10, wherein the upstream side baffle plate and the downstream side baffle plate include partition parts along the flowing direction of the first shielding gas, and a thickness of the partition part of the downstream side baffle plate is smaller than a thickness of the partition part of the upstream side baffle plate.

12. A shielding gas supply method comprising:
jetting first shielding gas along a shield surface at a first velocity set in advance from a first nozzle; and
jetting second shielding gas along and outside the first shielding gas at a second velocity lower than the first velocity from a second nozzle, wherein
the first nozzle is formed with a curved surface with which an area of a flow channel is gradually reduced toward a downstream side of a flowing direction of the first shielding gas,
the first nozzle includes an upstream side curved surface projecting outward on an upstream side of the flowing direction of the first shielding gas and a downstream side curved surface projecting inward on a downstream side of the flowing direction of the first shielding gas,
an inflection point is provided at a cross section passing through a center of gravity of the first nozzle between the upstream side curved surface and the downstream side curved surface,
the second nozzle includes a jetting port having a rectangular shape, and
the inflection point is arranged on a side opposite to the shield surface with respect to the first nozzle.
